(19) United States
(12) Patent Application Publication
(10) Pub. No.: US 2014/0354375 A1
(43) Pub. Date: Dec. 4, 2014

(54) Orthomode Transducers And Methods Of Fabricating Orthomode Transducers

(71) Applicant: Radio Frequency Systems, Inc., Meriden, CT (US)

(72) Inventors: Yin-Shing Chong, Middletown, CT (US); Peter Casey, Clinton, CT (US); Yunchi Zhang, Wallingford, CT (US)

(73) Assignee: Radio Frequency Systems, Inc., Meriden, CT (US)

(21) Appl. No.: 13/908,542

(22) Filed: Jun. 3, 2013

(51) Int. Cl. H01P 1/161; H01P 11/00

(52) U.S. Cl. CPC H01P 1/161; H01P 11/001
USPC 333/137; 264/1.24

(57) ABSTRACT

Orthomode transducers (OMTs) and methods of fabricating OMTs are disclosed. According to disclosed embodiments, an OMT includes a housing defining an internal waveguide. The housing may be composed of a first cast housing member attached to a second cast housing member. The first housing member may include a first side of the waveguide that is cast into the first housing member. The second housing member may include a second side of the waveguide that is cast into the second housing member. A method of fabricating an OMT may include arranging at least one casting insert in at least one mold, casting the housing in the mold and casting a waveguide in the housing using the at least one casting insert. The disclosed devices and methods provide cost effective solutions for fabricating OMTs of various operating frequencies that share a substantially similar outer housing shape and size.

### BACKGROUND OF THE INVENTION

As known to those in the art of microwave radio communications, an orthomode transducer (OMT) is a three-port device which can be used to separate and/or combine orthogonally polarized signals. The OMT is often used to receive signals of a first polarization and transmit signals of a second polarization. The OMT includes a housing that defines a waveguide including a first waveguide branch, a second waveguide branch coupled to the first waveguide branch, and a third waveguide branch coupled to the first and second waveguide branches. The first waveguide branch is configured to enable propagation of a signal having the first polarization. The second waveguide branch is configured to enable propagation of a signal having the second polarization. The third waveguide branch is configured to enable propagation of a signal having either the first polarization or the second polarization.

Microwave radio communication systems can operate over a wide range of frequencies (from 5 GHz to 80 GHz, for example). It is therefore necessary to provide OMTs that operate over many different frequencies. Because the size and/or configuration (e.g., shape) of the waveguide in an OMT varies with frequency, traditionally, several OMTs with differently sized waveguides need to be provided to cover all of the frequencies required for certain applications.

FIG. 1 shows a conventional OMT assembly 10. The assembly 10 includes a frame 20 and an OMT 30 secured to the frame 10. The OMT 30 is constructed of a machined block of material, such as aluminum or magnesium, and defines an internal waveguide (not shown). The OMT 30 includes a first port 40 including a first waveguide aperture 42 in a first side 30a of the OMT 30, a second port including a second waveguide aperture (not shown) in a second side 30b of the OMT 30 opposite the first side 30a, and a third port 60 including a third waveguide aperture 62 located at an end 30c of the OMT30. The first waveguide aperture 42 is located at an external end of a first waveguide branch (not shown) configured to enable propagation of a signal having a first polarization. The second waveguide aperture (not shown) is located at an external end of a second waveguide branch (not shown) configured to enable propagation of a signal having a second polarization. The third waveguide aperture 62 is located at an external end of a third waveguide branch (not shown) configured to enable propagation of a signal having either the first polarization or the second polarization.

Still referring to FIG. 1, radios (not shown) can be attached to first port 40 and the second port (not shown) to place the radios in communication with the first waveguide aperture 42 and the second waveguide aperture (not shown), respectively. A feed element mounting assembly 70 can be attached to the third port 60 to place a feed element or feed horn (not shown) in communication with the third waveguide aperture 62.

The assembly 10 is relatively expensive to manufacture, as it employs two parts (the frame 20 and the OMT 30), and machining of the OMT 30 (particularly, the waveguide) is expensive. Additionally, the assembly 10 is customer/application specific and, therefore, the frame 20 must be configured differently for each customer/application.

In view of the above, it is desirable to provide cost-effective methods of manufacturing OMTs having a wide range of operating frequencies. It is further desirable to provide OMTs that have a substantially consistent outer housing shape and size regardless of operating frequency.

### SUMMARY OF THE INVENTION

The disclosure relates to orthomode transducers (OMTs) for microwave radio antennas, and methods of fabricating OMTs. According to an embodiment of the invention, an OMT may include a cast housing and a cast waveguide in the housing. The cast waveguide may include: a first waveguide branch coupled to a first waveguide aperture and configured to support transmission of signals having a first polarization; a second waveguide branch coupled to a second waveguide aperture and configured to support transmission of signals having a second polarization opposite the first polarization; and a third waveguide branch coupled to a third waveguide aperture, the first waveguide branch and the second waveguide branch, wherein the third waveguide branch is configured to support transmission of signals having the first polarization and signals having the second polarization.

According to another embodiment, a method of fabricating an OMT includes arranging at least one casting insert in at least one mold, casting a housing in the at least one mold, and casting a waveguide in the housing using the at least one casting insert.

The OMTs and methods of manufacturing OMTs disclosed herein provide cost-effective and efficient solutions for providing OMTs having different waveguide configurations, but having housings of substantially uniform size and shape. Additional features and advantages will be apparent to those of ordinary skill in the art in view of the following detailed description and appended drawings.

### BRIEF DESCRIPTION OF THE DRAWINGS

FIG. 1 is a perspective view of a conventional orthomode transducer (OMT) assembly.

FIG. 2 shows an antenna including an orthomode transducer (OMT), according to an embodiment of the invention.

FIG. 3 is an exterior perspective view of the OMT of FIG. 2.

FIG. 4 is an exploded, exterior perspective view of the OMT of FIG. 2, generally opposite the view of FIG. 3.

FIG. 5 is an exploded, interior perspective view of the OMT of FIG. 2.

FIG. 6 shows an antenna sub-assembly including an OMT, according to another embodiment of the invention.

FIGS. 7 and 8 are exterior perspective views of the OMT of FIG. 6.

FIG. 9 is an exploded, interior perspective view of the OMT of FIG. 6.

### DETAILED DESCRIPTION OF THE INVENTION

The following description discloses novel orthomode transducers (OMTs) and novel methods of fabricating OMTs. The OMTs described herein are suitable for use in microwave radio communication devices, such as a very small aperture terminal (VSAT) antennas for satellite communications and terrestrial microwave radio antennas, for example. The OMTs disclosed herein may be configured to receive signals of a first polarization and transmit signals of a second polarization orthogonal to the first polarization. Alternatively, the OMTs may be configured to transmit signals of first and second polarizations or receive signals of first and second polarizations.

In the following description and associated drawings, reference numbers and characters repeated between the various embodiments indicate similar components and features. Throughout the description, reference is made to various directions, such as “horizontal”, “horizontally”, “vertical”, “vertically”, “diagonal” and “diagonally.” These terms are used to reference directions relative to an OMT in a typical position for use. However, it should be understood that such directional terms are relative terms used to facilitate understanding of the devices as shown in the appended drawings, and are not intended to be limiting. Further, the use of the word “includes” in the following description is meant to be non-limiting. When the word “includes” is used to describe the inclusion of a component or feature, it should be understood that the specific component described is non-limiting, and there may be other equivalent components or features that fall within the scope of the invention. Alternatively, the inclusion of the component may be optional. It may be appropriate to interpret the word “includes” as meaning “may include,” depending on the context of the discussion.

It should be further understood that, although the terms first, second, third, etc. may be used herein to describe various elements, the elements should not be limited by these terms. Such terms are used to distinguish one element from another. For example, a first element could be termed a second element, and, similarly, a second element could be termed a first element, without departing from the scope of disclosed embodiments. It should be understood that when an element is referred to as being “connected”, “coupled” or “attached” to another element, it may be directly connected, coupled or attached to the other element, or intervening elements may be present, unless otherwise specified. Additional words used to describe connective or spatial relationships between elements or components (e.g., “between”) should be interpreted in a like fashion.

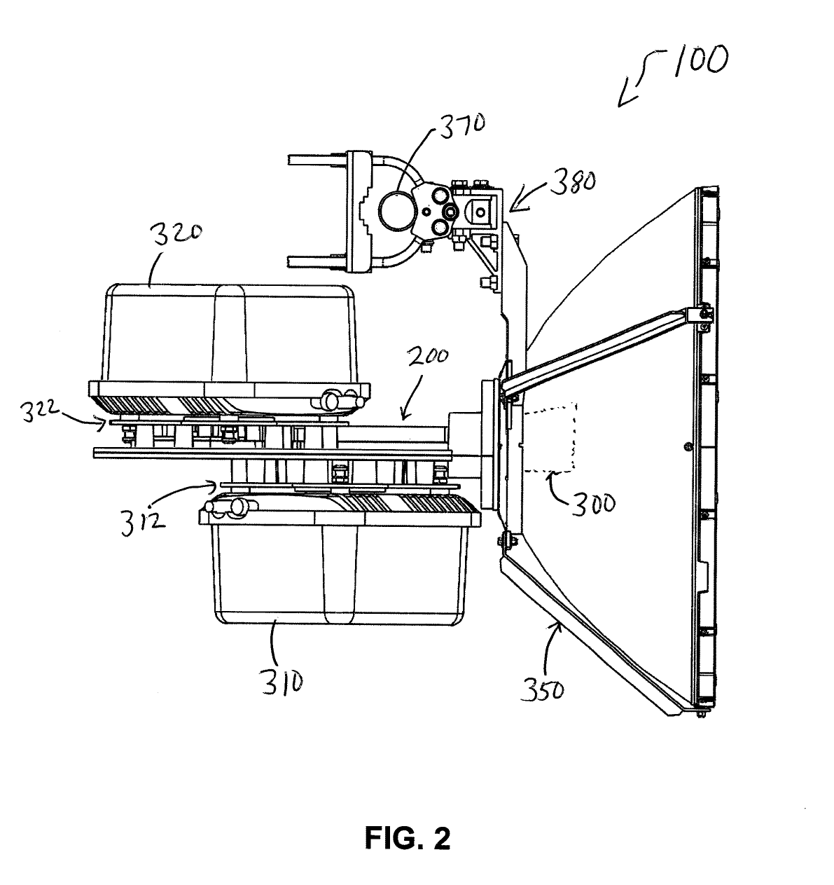

Turning now to the figures, FIG. 2 depicts an exemplary antenna 100 for a communication system according to an embodiment of the invention. The antenna 100 may be, for example, a very small aperture terminal (VSAT) antenna or a terrestrial microwave radio antenna, operating over the range of 6 to 80 gigahertz. However, it should be understood that the antenna 100 may operate over other frequency ranges.

As shown in FIG. 2, the antenna 100 may include an orthomode transducer (OMT) 200, a feed element 300 (e.g., feed horn) attached to and in communication with the OMT 200, a first radio 310 attached to the OMT 200, a second radio 320 attached to the OMT 200, and a reflector 350 configured to reflect signals to and from the feed element 300. Additional waveguide elements, such as a circular polarizer (not shown) may be attached between the OMT 200 and the feed element 300, depending on the application.

According to an embodiment, the first radio 310 may be a receiver and the second radio 320 may be a transmitter, or vice-versa. According other embodiments, both radios 310, 320 may be transmitters or both radios 310, 320 may be receivers.

As shown in FIG. 2, the antenna 100 may be mounted on a pole 370 via a mounting bracket 380 attached to the reflector 350 and/or the OMT 200. However, other mounting arrangements are possible.

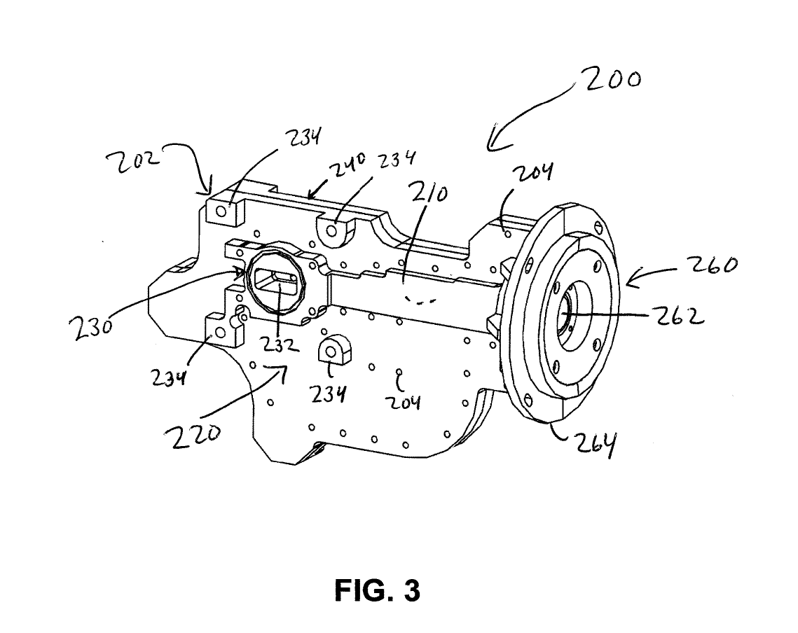

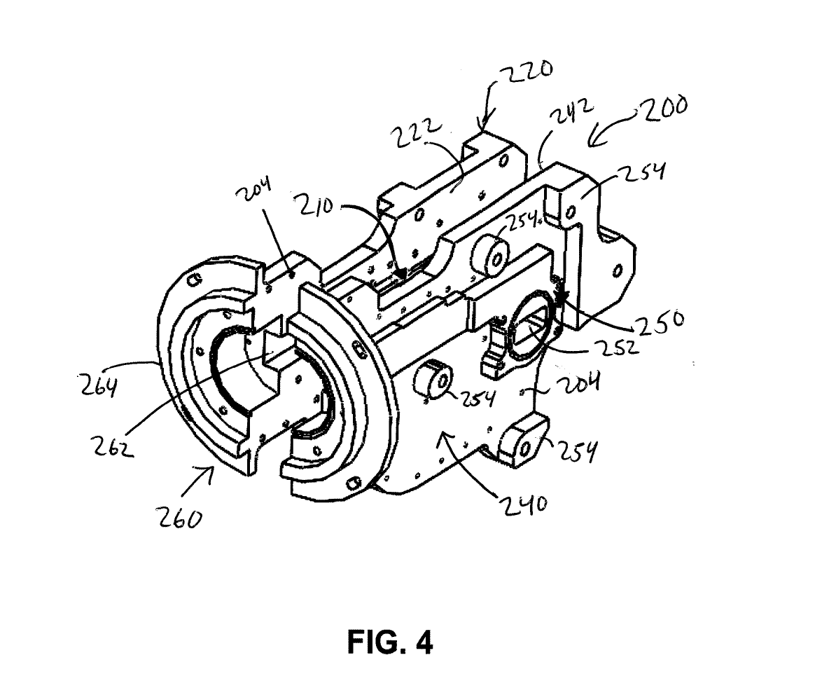

Referring now to FIGS. 3 and 4, the OMT 200 includes a housing 202 that defines an electrically conductive waveguide 210 within its interior. The housing 202 is composed of a first housing member or portion 220 and a second housing member or portion 240. The first housing member 220 and the second housing member 240 may be of similar shape and size, and may each form approximately one half of the housing 202. When the OMT 200 is in an assembled configuration (FIG. 3), the housing members 220, 240 are attached to each other at their respective inner surfaces 222, 242 (FIG. 4) and may be secured together by fasteners (not shown) received in holes 204. In addition to or in place of being secured together by fasteners, the housing members 220, 240 may be secured together by adhesive or welds. The housing members 220, 240 may be castings constructed of aluminum, magnesium, plastic, a polymer or another suitably strong material.

Referring to FIG. 3, the housing 202 may include a first port 230 located on the first housing member 220 and having a first waveguide aperture 232 formed therein. The first waveguide aperture 232 may be configured to communicate with the first radio 310 and may be configured, for example, to support the transmission of signals having a first polarization (e.g., horizontal). Bosses 234 may be included on or near the first port 230 for interfacing with a mounting ring or mounting member 312 (FIG. 2) that attaches the first radio 310 to the first housing member 220.

As shown in FIG. 4, the housing 202 may include a second port 250 located on the second housing member 240 and having a second waveguide aperture 252 formed therein. The second waveguide aperture 252 may be configured to communicate with the second radio 320 and may be configured, for example, to support the transmission of signals having a second polarization (e.g., vertical) orthogonal to the first polarization. Bosses 254 may be included on or near the second port 250 for interfacing with a mounting ring or mounting member 322 (FIG. 2) that attaches the second radio 320 to the second housing member 240.

Referring to FIGS. 3 and 4, the housing 202 may include a third, common port 260 having a third waveguide aperture 262 formed therein. The third port 260 may be located on the first and second housing members 220, 240 such that each housing member 220, 240 forms half or approximately half of the third port 260 and the third waveguide aperture 262. The third waveguide aperture 262 may be configured to communicate with the feed element 300 and may be configured, for example, to support the transmission of signals having the first polarization and signals having the second polarization. A flange 264 may be included on the third port 260 for attaching the feed element 300 and the reflector 350 to the housing 202.

As illustrated in FIGS. 3 and 4, the first and second ports 230, 250 are located on horizontally opposed sides of the housing 202 and such that their surfaces may be substantially parallel to each other, thereby positioning the first and second waveguide apertures 232, 252 in side-by-side orientation. Accordingly, the first waveguide aperture 232 lies in a plane that is parallel to the plane in which the second waveguide aperture 252 lies. The surface of the third port 260 may be orthogonal or substantially orthogonal to the surfaces of the first and second ports 230, 250, such that the third waveguide aperture 262 lies in a plane that is orthogonal or substantially orthogonal to the planes in which the first and second waveguide apertures lie.

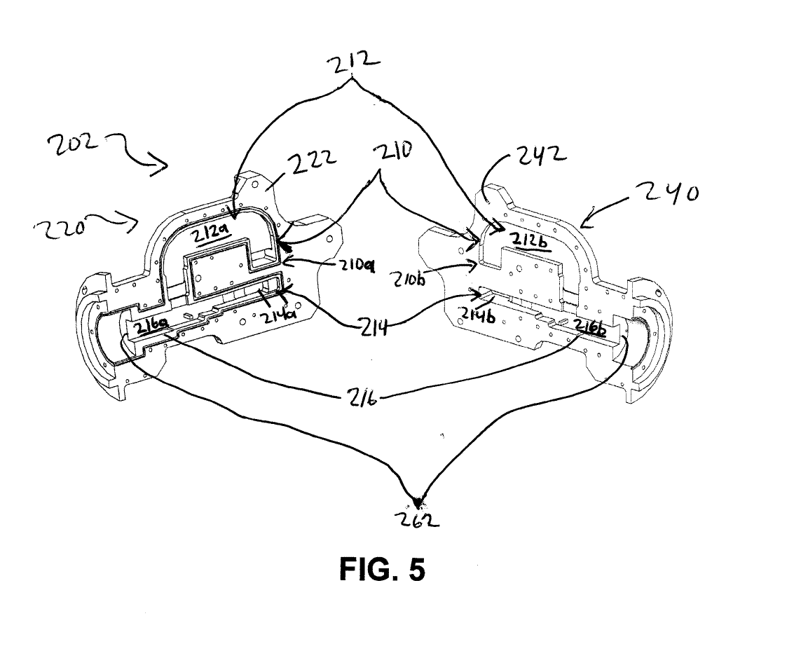

Still referring to FIGS. 3 and 4, the first and second waveguide apertures 232, 252 are illustrated as being rectangular-shaped and having similar orientations, and the third waveguide aperture 262 is illustrated as being square-shaped. It is noted that the similar orientations of the first and second waveguide ports 232, 252 illustrated in FIGS. 3 and 4 are possible because the waveguide branch 214 (FIG. 5) coupled to the second waveguide aperture 252 is twisted within the housing 202. It should be understood that it is possible for the waveguide apertures 232, 252, 262 and the waveguide 210 to have shapes and orientations other than those specifically illustrated and described herein.

FIG. 5 is an exploded, interior view of the housing 202 showing the waveguide 210 in detail. The waveguide 210 may be a cast pathway composed of pathway portions that are integrally cast with the housing members 220, 240. In embodiments in which the housing members 220, 240 are constructed of a material that is not electrically conductive, the surfaces of the waveguide 210 may be coated with an electrically conductive material.

As shown in FIG. 5, the waveguide 210 may include a first waveguide branch 212 coupled to the first waveguide aperture 232 and configured for transmission of signals of the first polarization, a second waveguide branch 214 coupled to the second waveguide aperture 252 and configured for transmission of signals of the second polarization, and a third, common waveguide branch 216 coupled to first and second waveguide branches 212, 214 and the third waveguide aperture 262, and configured for transmission of signals of the first polarization and the second polarization. The first waveguide branch 212 may have an inverted “U” shape and may be orthogonal to the third waveguide branch 216 where it intersects the third waveguide branch 216. The second waveguide branch 214 may be substantially coaxial with the third waveguide branch 216, and may be vertically spaced from the first waveguide branch 212.

As can be seen in FIG. 5, the first housing member 220 includes a first side 210a of the waveguide 210 and the second housing member 240 includes a second side 210b of the waveguide 210. The first side 210a of the waveguide 210 includes first sides 212a, 214a, 216a of the waveguide branches 212, 214, 216. The second side 210b of the waveguide 210 includes second sides 212b, 214b, 216b of the waveguide branches 212, 214, 216. When the first and second housing members 220, 240 are attached to each other to form the complete housing 202, the first and second sides 210a, 210b of the waveguide 210 are aligned with each other such that the first sides 212a, 214a, 216a of the waveguide branches 212, 214, 216 are aligned the second sides 212b, 214b, 216b of the waveguide branches 212, 214, 216. Thus, the first and second sides 210a, 210b of the waveguide 210 interface with each other to form the waveguide 210.

In order to improve fabrication efficiency and reduce fabrication costs, the OMT 200 may be fabricated by a method including casting the housing 202. According to an exemplary method, the first housing member 220 may be cast in a first mold and the second housing member 240 may be cast in a second mold. Alternatively, the first and second housing members 220, 240 may be cast in the same mold. The first and second sides 210a, 210b of the waveguide 210 may be cast in the housing members 220, 240, respectively, by arranging one or more casting inserts in the mold(s). The one or more casting inserts may be arranged, sized and shaped as desired to produce the desired arrangement, size and shape of the first and second sides 210a, 210b of the waveguide 210. Thus, the operating frequency of OMTs 200 can be varied by simply using different casting inserts, while using the same housing mold(s). If the sides 210a, 210b of the waveguide 210 are cast from a non-conductive material, they may be coated with a conductive material after casting. After casting the housing members 220, 240, the housing members 220, 240 may be attached to each other such that the first and second sides 210a, 210b of the waveguide 210 are aligned with each other and interface with each other to form the waveguide 210.

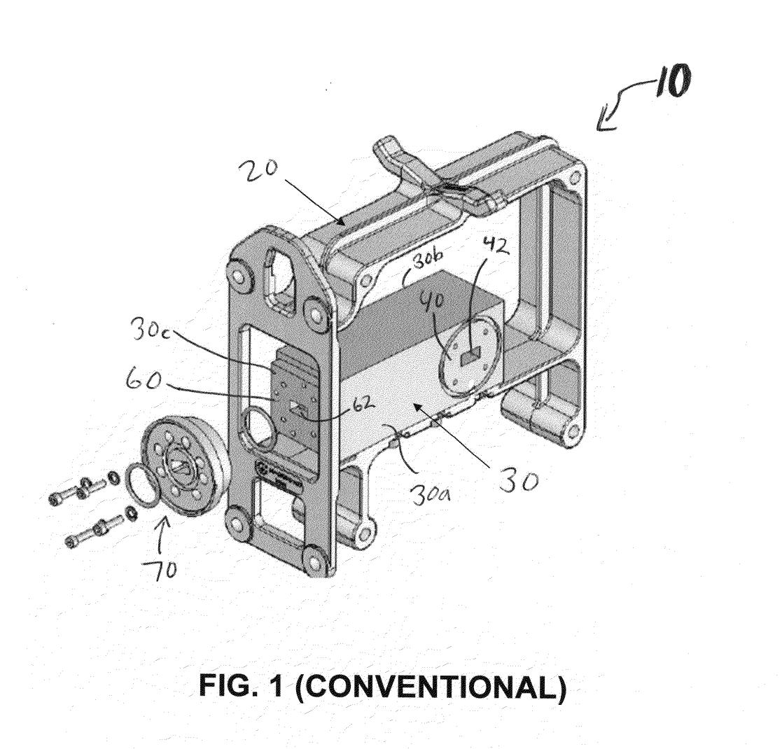

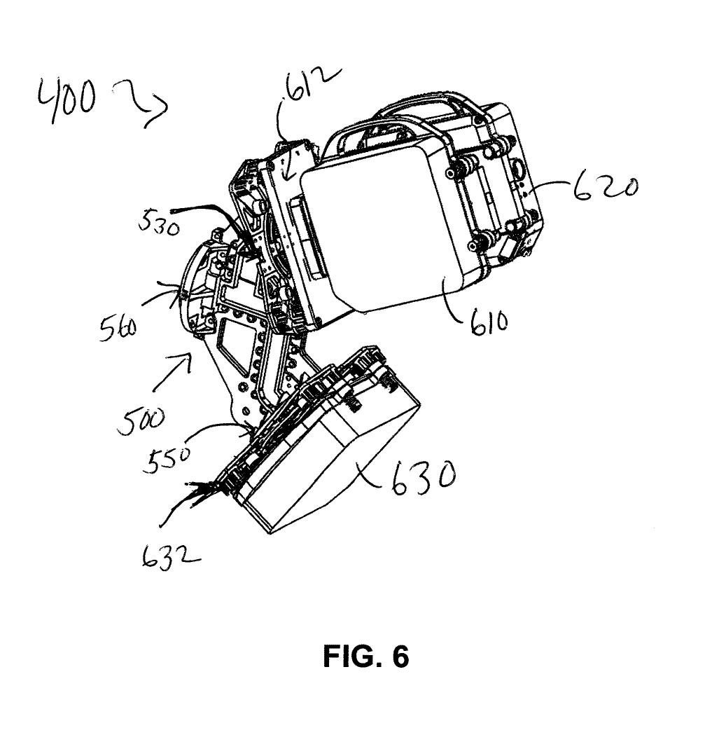

FIG. 6 shows an exemplary antenna sub-assembly 400 for a communication system according to another embodiment. The sub-assembly antenna 400 may be used in, for example, a very small aperture terminal (VSAT) antenna or a terrestrial microwave radio antenna, operating over the range of 6 to 80 gigahertz. However, the sub-assembly 400 may be used in antennas operating in other frequency ranges. As shown in FIG. 6, the sub-assembly 400 may include an OMT 500 and first, second and third radios 610, 620, 630 attached to and in communication with the OMT 500. When used in an antenna, the OMT 500 may be connected to a feed element (not shown) and a reflector (not shown) similar to those illustrated in FIG. 1.

According to an exemplary embodiment, the first and second radios 610, 620 may be receivers and the third radio 630 may be a transmitter, or vice-versa. According other embodiments, all three radios 610, 620, 630 may be receivers or all three radios 610, 620, 630 may be transmitters. The OMT 500 may be configured to receive signals of a first polarization and transmit signals of a second polarization orthogonal to the first polarization. Alternatively, the OMT 500 may be configured to transmit signals of the first and second polarizations or receive signals of the first and second polarizations.

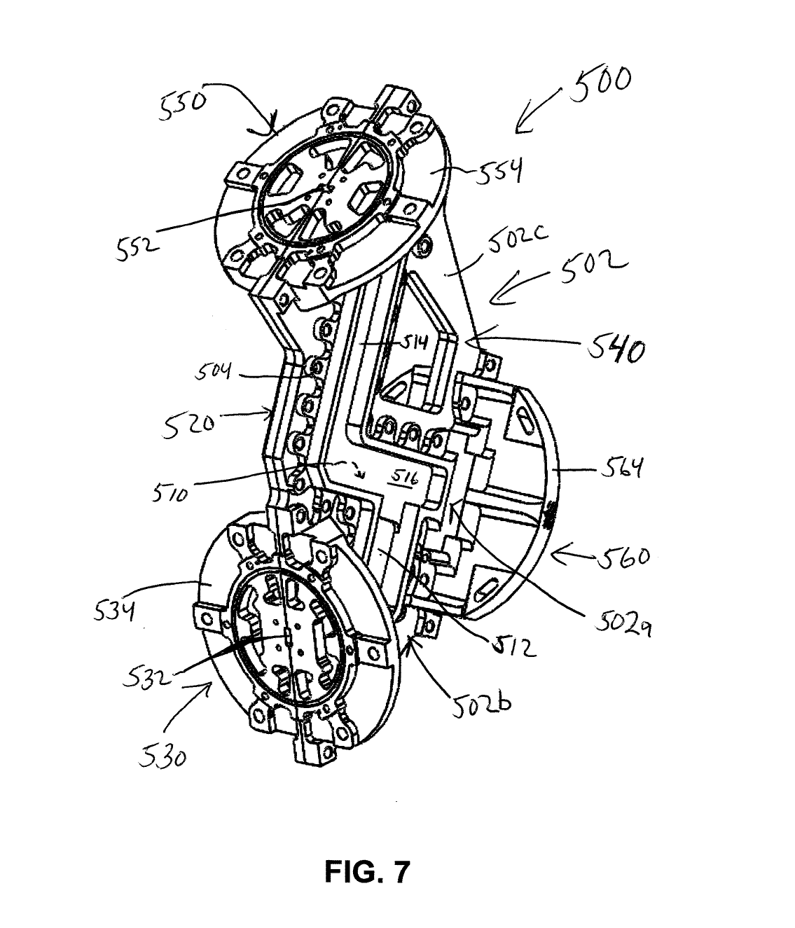

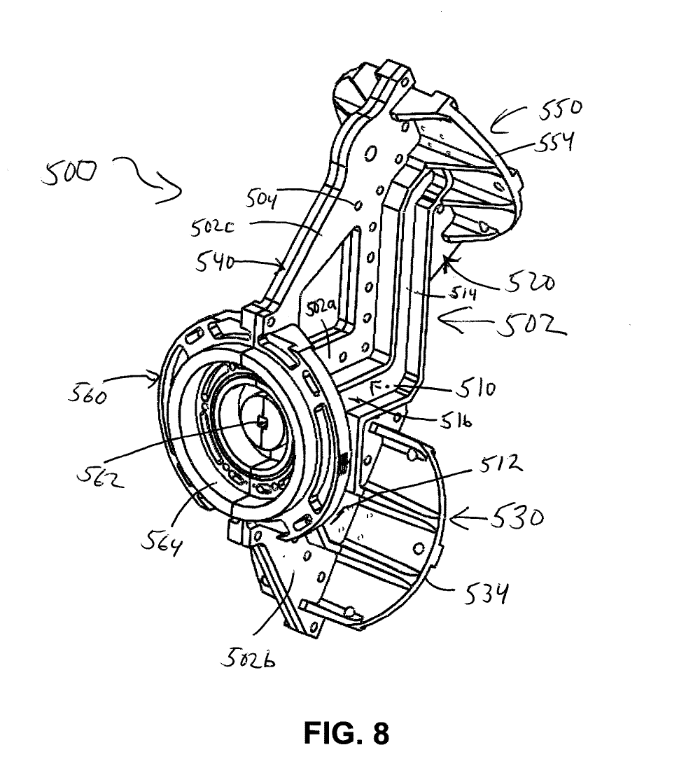

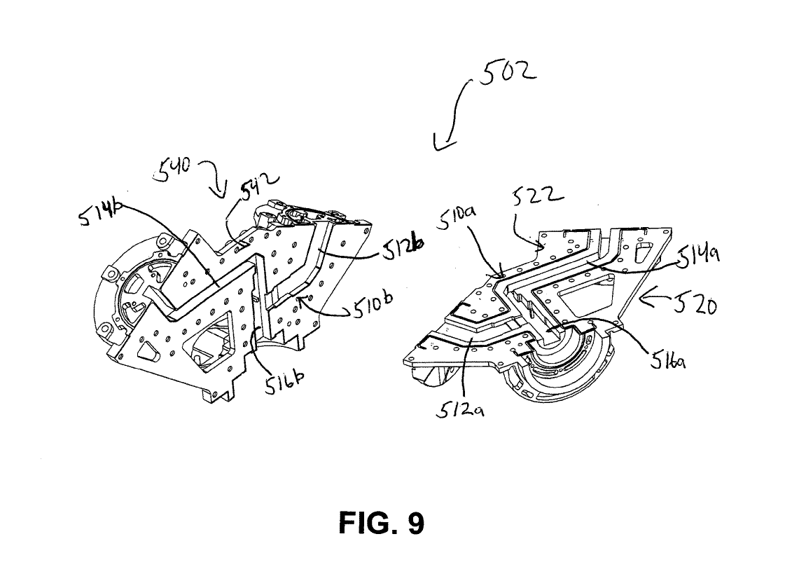

Turning to FIGS. 7 and 8, the OMT 500 includes a housing 502 that defines an electrically conductive waveguide 510 within its interior. The housing 502 is composed of a first housing member or portion 520 and a second housing member or portion 540. The first housing member 520 and the second housing member 540 may each have a similar shape and size, and they may each form approximately one half of the housing 502. When the OMT 500 is in an assembled configuration as shown in FIGS. 7 and 8, the housing members 520, 540 are attached to each other at their respective inner surfaces 522, 542 (FIG. 9) and may be secured together by fasteners (not shown) received in holes 504. The housing members 220, 240 may be secured together by adhesive or welds, in addition to or in place of being secured together by fasteners. The housing members 520, 540 may be castings constructed of aluminum, magnesium, plastic, a polymer or another suitably strong material.

As illustrated in FIG. 7, the housing 502 may include a first port 530 formed by the first and second housing members 520, 540 and having a first waveguide aperture 532 formed therein. Each housing member 520, 540 may form half or approximately half of the first port 530 and first waveguide aperture 532. The first waveguide aperture 532 may be configured to communicate with the first and second radios 610, 620 and may be configured, for example, to support the transmission of signals having a first polarization (e.g., horizontal). A flange 534 may be included on the first port 530 for interfacing with a mounting ring or mounting member 612 (FIG. 6) that attaches the first and second radios 610, 620 to the first and second housing members 520, 540.

Still referring to FIG. 7, the housing 502 may include a second port 550 formed by the first and second housing members 520, 540 and having a second waveguide aperture 552 formed therein. Each housing member 520, 540 may form half or approximately half of the second port 550 and second waveguide aperture 552. The second waveguide aperture 552 may be configured to communicate with the third radio 630 and may be configured, for example, to support the transmission of signals having a second polarization (e.g., vertical) orthogonal to the first polarization. A flange 554 may be included on the second port 550 for interfacing with a mounting ring or mounting member 632 (FIG. 6) that attaches the third radio 630 to the first and second housing members 520, 540.

Turning to FIG. 8, the housing 502 may include a third, common port 560 formed by the first and second housing members 520, 540 and having a third waveguide aperture 562 formed therein. Each housing member 520, 540 may form half or approximately half of the third port 560 and third waveguide aperture 562. The third waveguide aperture 562 may be configured to communicate with a feed element (not shown) and may be configured, for example, to support the transmission of signals having the first polarization and signals having the second polarization. A flange 564 may be included on the third port 560 for attaching a feed element and a reflector (not shown) to the housing 502.

The first and second waveguide apertures 532, 552 are illustrated in FIGS. 7 and 8 as being rectangular-shaped and having generally opposite orientations, and the third waveguide aperture 562 is illustrated as being square-shaped. It should be understood, however, that it is possible for the waveguide apertures 532, 552, 562 and the waveguide 510 to have shapes and orientations other than those specifically illustrated and described herein.

Referring to FIGS. 7 and 8, the housing 502 may include a center section 502a including the third port 550, a first arm 502b including the first port 530 and extending in a first diagonal direction from the center section 502a and, and a second arm 502c including the second port 550 and extending in a second diagonal direction from the center section 502a, substantially opposite the first diagonal direction. Thus, the housing 502 may be characterized as a substantially V-shaped or substantially U-shaped member. The first port 530 may lie within a plane that is transverse to the plane in which the second port 550 lies, and the third port 560 may lie within a plane that is transverse to the planes in which the first and second ports 530, 550 lie. Accordingly, the first waveguide aperture 532 may lie within a plane that is transverse to the plane in which the second waveguide aperture 552 lies, and the third waveguide aperture 562 may lie within a plane that is transverse to the planes in which the first and second waveguide apertures 532, 552 lie.

As illustrated in FIG. 7, the waveguide may include a first waveguide branch 512 coupled to the first waveguide aperture 532 and configured for transmission of signals of the first polarization, a second waveguide branch 514 coupled to the second waveguide aperture 552 and configured for transmission of signals of the second polarization, and a third, common waveguide branch 516 coupled to first and second waveguide branches 512, 514 and the third waveguide aperture 562, and configured for transmission of signals of the first polarization and the second polarization. The first waveguide branch 512 may be substantially V-shaped and may be orthogonal to the third waveguide branch 516 where it intersects the third waveguide branch 516. The second waveguide branch 514 may be substantially L-shaped with a portion that is substantially coaxial with the third waveguide branch 516 at the intersection of the second waveguide branch 514 and the third waveguide branch 516.

FIG. 9 is an exploded, interior view of the housing 502 showing the waveguide 510 in detail. The waveguide 210 may be a cast pathway composed of pathway portions that are integrally cast with the housing members 520, 540. In embodiments in which the housing members 520, 540 are constructed of a material that is not electrically conductive, the surfaces of the waveguide 510 may be coated with an electrically conductive material.

Referencing FIG. 9, the first housing member 520 includes a first side 510a of the waveguide 510 and the second housing member 540 includes a second side 510b of the waveguide 510. The first side 510a of the waveguide 510 includes first sides 512a, 514a, 516a of the waveguide branches 512, 514, 516. The second side 510b of the waveguide 510 includes second sides 512b, 514b, 516b of the waveguide branches 512, 514, 516. When the first and second housing members 520, 540 are attached to each other to form the complete housing 502, the first and second sides 510a, 510b of the waveguide 510 are aligned with each other such that the first sides 512a, 514a, 516a of the waveguide branches 512, 514, 516 are aligned with the second sides 512b, 514b, 516b of the waveguide branches 512, 514, 516. Accordingly, the first and second sides 510a, 510b of the waveguide 510 interface with each other to form the waveguide 510.

The configuration of the OMT 500 provides a compact structure and enables mounting of the radios 610, 620, 630 in close proximity to a reflector. According to an embodiment, the OMT 500 may be arranged in an antenna such that the first arm 502b and the second arm 502c lie within a substantially vertical plane, thereby positioning the first port 530 vertically above the second port 550 (or vice-versa), as shown in FIG. 6, with the first and second ports 530, 550 being substantially horizontally aligned. Such an arrangement provides the benefit of reducing potential interference of a mounting pole (e.g., pole 570 shown in FIG. 1) with the radios 610, 620, 630.

The OMT 500 may be fabricated by a method including casting the housing 502. According to an exemplary method, the first housing member 520 may be cast in a first mold and the second housing member 540 may be cast in a second mold. According to another alternate embodiment, the first and second housing members 520, 540 may be cast in the same mold. The first and second sides 510a, 510b of the waveguide 510 may be cast in the respective housing members 520, 540 by arranging one or more casting inserts in the mold(s). The one or more casting inserts may be arranged, sized and shaped as desired to produce the desired arrangement, size and shape of the first and second sides 510a, 510b of the waveguide 510. Accordingly, the operating frequency of OMTs 500 can be varied by using different casting inserts, while using the same housing mold(s). If the sides 510a, 510b of the waveguide 510 are cast from a non-conductive material, they may be coated with a conductive material after casting. After casting the housing members 520, 540, the housing members 520, 540 may be attached to each other such that the first and second sides 510a, 510b of the waveguide 510 are aligned with each other and interface with each other to form the waveguide 510.

The disclosed inventions provide OMTs that are efficient and cost-effective to manufacture. The disclosed methods of fabricating OMTs by casting OMT housings and waveguides enable OMTs of various operating frequencies to be produced without substantially changing the casting mold(s). Therefore, the cost of producing OMTs may be reduced, and the outer form (e.g., shape and size) of the OMT housings for OMTs of various frequencies may be substantially the same.

It should be understood that the devices and methods disclosed herein are merely exemplary embodiments of the invention. One of ordinary skill in the art will appreciate that changes and variations to the disclosed embodiments can be made without departing from the spirit and scope of the inventions as set forth in the appended claims.

We claim:

1. An orthomode transducer, comprising:
a cast housing; and
a cast waveguide in the housing, wherein the cast waveguide comprises,
a first waveguide branch coupled to a first waveguide aperture and configured to support transmission of signals having a first polarization,
a second waveguide branch coupled to a second waveguide aperture and configured to support transmission of signals having a second polarization opposite the first polarization, and
a third waveguide branch coupled to a third waveguide aperture, the first waveguide branch and the second waveguide branch, wherein the third waveguide branch is configured to support transmission of signals having the first polarization and signals having the second polarization.

2. The orthomode transducer of claim 1, wherein the housing comprises:
a first housing member comprising a first side of the cast waveguide; and
a second housing member attached to the first housing member and comprising a second side of the cast waveguide.

3. The orthomode transducer of claim 2, wherein the first waveguide aperture is in the first housing member, the second waveguide aperture is in the second housing member and the third waveguide aperture is in the first and second housing members.

4. The orthomode transducer of claim 2, wherein each of the first, second and third waveguide apertures is in the first and second housing members.

5. The orthomode transducer of claim 1, wherein the first waveguide aperture is in a first plane, the second waveguide aperture is in a second plane that is substantially parallel to the first plane, and the third waveguide aperture is in a third plane that is substantially orthogonal to the first and second planes.

6. The orthomode transducer of claim 1, wherein the first waveguide aperture is in a first plane, the second waveguide aperture is in a second plane that is transverse to the first plane, and the third waveguide aperture is in a third plane that is transverse to the first and second planes.

7. The orthomode transducer of claim 1, wherein the housing comprises:
a first arm extending in a first diagonal direction and comprising a first port defining the first waveguide aperture;
a second arm extending in a second diagonal direction and comprising a second port defining the second waveguide aperture, the second diagonal direction being substantially opposite the first diagonal direction; and
a central portion attached to the first arm and the second arm, and comprising a third port defining the third waveguide aperture.

8. The orthomode transducer of claim 1, wherein the housing is constructed of one of the following materials: aluminum, magnesium, plastic and a polymer.

9. A method of fabricating an orthomode transducer, comprising:
arranging at least one casting insert in at least one mold;
casting a housing in the at least one mold; and
casting a waveguide in the housing using the at least one casting insert.

10. The method of claim 9, wherein:
casting the housing comprises casting a first housing member and a second housing member; and
casting the waveguide in the housing comprises casting a first side of the waveguide in the first housing member, and casting a second side of the waveguide in the second housing member.

11. The method of claim 10, wherein casting the waveguide in the housing further comprises:
casting a first waveguide branch such that the first waveguide branch is coupled to a first waveguide aperture in the first housing member, and the first waveguide branch is configured to support transmission of signals having a first polarization,
casting a second waveguide branch such that the second waveguide branch is coupled to a second waveguide aperture in the second housing member, and the second waveguide branch is configured to support transmission of signals having a second polarization opposite the first polarization, and
casting a third waveguide branch such that the third waveguide branch is coupled to the first waveguide branch, the second waveguide branch and a third waveguide aperture in the first and second housing members, and the third waveguide branch is configured to support transmission of signals having the first polarization and signals having the second polarization.

12. The method of claim 11, wherein the first waveguide aperture is in a first plane, the second waveguide aperture is in a second plane that is substantially parallel to the first plane, and the third waveguide aperture is in a third plane that is substantially orthogonal to the first and second planes.

13. The method of claim 10, wherein casting the waveguide in the housing further comprises:
casting a first waveguide branch such that the first waveguide branch is coupled to a first waveguide aperture in the first and second housing members, and the first waveguide branch is configured to support transmission of signals having a first polarization,
casting a second waveguide branch such that the second waveguide branch is coupled to a second waveguide aperture in the first and second housing members, and the second waveguide branch is configured to support transmission of signals having a second polarization opposite the first polarization, and
casting a third waveguide branch such that the third waveguide branch is coupled to the first waveguide branch, the second waveguide branch and a third waveguide aperture in the first and second housing members, and the third waveguide branch is configured to support transmission of signals having the first polarization and signals having the second polarization.

14. The method of claim 13, wherein the first waveguide aperture is in a first plane, the second waveguide aperture is in a second plane that is transverse to the first plane, and the third waveguide aperture is in a third plane that is transverse to the first and second planes.

15. The method of claim 10, further comprising:
aligning the first housing member with the second housing member such that the first side of the waveguide is aligned with the second side of the waveguide; and
attaching the first housing member to the second housing member such that first side of the waveguide interfaces with the second side of the waveguide.

16. The method of claim 9, wherein casting the housing comprises:
casting a first arm extending in a first diagonal direction and comprising a first port defining a first waveguide aperture;
casting a second arm extending in a second diagonal direction and comprising a second port defining a second waveguide aperture, the second diagonal direction being substantially opposite the first diagonal direction; and
casting a central portion attached to the first arm and the second arm, and comprising a third port defining a third waveguide aperture.

17. The method of claim 9, further comprising casting the housing from one of the following materials: aluminum, magnesium, plastic and a polymer.
